(19) United States
(12) Patent Application Publication
(10) Pub. No.: US 2024/0412507 A1
(43) Pub. Date: Dec. 12, 2024

(54) SITE SELECTION AND MONITORING

(71) Applicant: Maxar Intelligence Inc., Westminster, CO (US)

(72) Inventors: Jennifer Horowitz, Los Angeles, CA (US); Deven Desai, Westminster, CO (US); Wenliang Zhou, Westminster, CO (US)

(21) Appl. No.: 18/738,698

(22) Filed: Jun. 10, 2024

Related U.S. Application Data
(60) Provisional application No. 63/507,284, filed on Jun. 9, 2023.

(51) Int. Cl. G06V 20/13; G06V 10/32

(52) U.S. Cl. CPC G06V 20/13; G06V 10/32

(57) ABSTRACT

This disclosure presents a novel method and system for remotely identifying physical locations that meet specific criteria. The method involves obtaining source input data and satellite imagery, which are pre-processed and normalized to form a digital representation of the Earth. Three-dimensional and mosaic data are then produced, corresponding to the digital earth, and geospatial analysis is performed based on the defined criteria. The analysis includes object recognition and the application of machine learning algorithms to identify features of interest. The method further involves identifying candidate locations that meet the criteria and optionally monitoring them through satellite tasking. A computer system and non-transitory storage medium are also described, incorporating artificial intelligence algorithms and spatial statistics visualization to facilitate the identification and monitoring processes. This innovative approach offers a comprehensive and efficient means of remotely identifying and assessing potential locations for various applications such as site selection, monitoring, and decision-making.

### TECHNICAL FIELD

Example embodiments described herein relate generally to the field of using satellite or aerial images to perform image analysis or image enhancement, in particular for remote sensing and monitoring applications. In particular, disclosure herein describes imaging techniques and systems that can be used to identify, model, select, and monitor sites of interest for particular applications.

### BACKGROUND

Geographic Information Systems (GIS) is a powerful tool that combines geography, data, and computer science to capture, store, manipulate, analyze, and present spatial or geographical data. GIS can incorporate data obtained through various data collection methods, such as satellite imagery, aerial photography, GPS, and surveying, to gather information about geographic features and their attributes. This data is then organized and stored, allowing it to be accessed, manipulated, and displayed.

GIS can be used with a wide range of tools and techniques to perform spatial analysis. This can include includes overlaying multiple layers of data to identify patterns and relationships, performing proximity analysis to determine the nearest features, and conducting network analysis to optimize routing and transportation. These analytical capabilities provide valuable insights and aid in decision-making processes.

GIS finds applications in numerous fields, including urban planning, environmental management, transportation, agriculture, and emergency response. In urban planning, GIS helps in land-use mapping, infrastructure planning, and predicting the impact of development projects. In environmental management, GIS is used to monitor and analyze natural resources, track deforestation, and assess the impact of climate change. Transportation agencies utilize GIS for route optimization, traffic management, and public transportation planning. Agriculture benefits from GIS by optimizing crop management, analyzing soil conditions, and monitoring the spread of pests and diseases. During emergencies, GIS aids in disaster response and recovery efforts by providing real-time mapping and analysis of affected areas.

GIS has become an essential tool in understanding and analyzing spatial data. Its applications in urban planning, environmental management, transportation, agriculture, and emergency response have led to improved decision-making and resource management. The impact of GIS is far-reaching, providing valuable insights and aiding in the advancement of numerous fields.

Site selection is one implementation of GIS. GIS offers a powerful solution for site selection by using source data, conducting geospatial analysis, and generating candidates based on site criteria inputs. By inputting relevant data, such as municipal data for permitting processes, climate forecasts, AIS vessel information, socioeconomic data, land use/land cover maps, geolocation data, demographic information, land use, infrastructure, and environmental factors, GIS can analyze the spatial relationships between these variables. Through geospatial analysis techniques, including proximity analysis, overlay analysis, and suitability modeling, GIS can identify and prioritize areas that meet specific site criteria. By considering factors like accessibility, population density, surrounding geological and manmade features, and environmental risks, GIS generates a comprehensive evaluation of potential sites for different uses. This information can be visually showcased through maps, charts, and reports, allowing stakeholders to make informed decisions and select the most suitable locations for various uses.

### SUMMARY

Aspects of this disclosure relate to a comprehensive method and system for remotely identifying physical locations that meet specific criteria. The disclosed method involves obtaining source input data and satellite imagery, which are pre-processed and normalized to create a digital representation of the Earth, referred to as the “digital earth.” The digital earth includes refreshed three-dimensional and mosaic data that accurately represent the physical environment.

To identify candidate locations fitting the defined criteria, the disclosed method employs geospatial analysis techniques. This analysis encompasses various processes, such as object recognition and the utilization of machine learning algorithms. By analyzing the refreshed three-dimensional and mosaic data, the method determines the suitability of each location based on the defined criteria.

Additionally, the disclosed method includes the option to display a three-dimensional image of the identified candidate locations, providing users with a visual representation of the sites. It also offers the capability to monitor these candidate locations, which may involve satellite tasking at a predefined interval. Monitoring enables real-time tracking and detection of any changes occurring within the locations.

The method further incorporates a digital twin concept, where geospatial data associated with a plurality of locations is received and combined with external data. This information is used to construct a comprehensive digital model for analysis and decision-making. The digital twin is continuously updated through satellite tasking, ensuring that the data remains current and accurate.

The disclosed system comprises a computer system with a non-transitory storage medium that contains artificial intelligence algorithms for geospatial analysis. The system includes an input for receiving two-dimensional data from satellites and three-dimensional data corresponding to a plurality of candidate locations. A display is integrated into the system to present the identified candidate locations visually.

The system also facilitates spatial statistics visualization, such as histograms and heatmaps, to provide detailed information about the results of object detection. It allows for efficient monitoring of the candidate locations by sending signals for additional satellite tasking if necessary. Furthermore, the system incorporates an archive of scouted locations and offers the flexibility to modify the timing of satellite tasking to optimize monitoring efficiency.

Aspects of this disclosure relate to methods and systems that enable remote identification of physical locations fitting specific criteria by leveraging geospatial analysis, satellite imagery, and a digital earth representation. This innovative approach improves site selection processes, monitoring capabilities, and decision-making efficiency across various industries.

### BRIEF DESCRIPTION OF THE DRAWINGS

The features and advantages of the example embodiments of the invention presented herein will become more apparent from the detailed description set forth below when taken in conjunction with the following drawings.

FIG. 1A is a flowchart of a site selection and monitoring method.

FIG. 1B is a detailed view of the flowchart of FIG. 1A, further depicting combinations of data that can be used to identify candidate locations.

FIG. 2 shows an example graphical user interface for obtaining satellite imagery according to the method of FIG. 1A.

FIGS. 3A and 3B show pre-processed imagery that incorporates both obtained source input data and satellite imagery according to the method of FIG. 1A.

FIG. 4 depicts an example block diagram of a virtual or physical operating environment.

FIG. 5 is a displayed image related to a candidate location identified according to the methods of FIGS. 1A and 1B.

FIG. 6 shows the overlay of multiple data sets, in this case a digital elevation model and building data.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION

The example embodiments of the invention presented herein are directed to methods, systems and computer program products for locating and monitoring sites of interest using a combination of satellite imagery and other data sources. Consistent with embodiments of the disclosure, a geospatial data process may assist individuals with investigating, and scouting locations better understanding change and pattern of life within a variety of locations in service of plethora of sectors and use cases using geodata and advanced geodata toolkits.

Illustrative examples of the disclosure are described below. In the interest of clarity, not all features of an actual implementation are described in this specification. It will of course be appreciated that in the development of any such actual example, numerous implementation-specific decisions must be made to achieve the developers' specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

Unless otherwise defined, all terms (including technical and scientific terms) used herein have the same meaning as commonly understood by one of ordinary skill in the art of this disclosure. It will be further understood that terms, such as those defined in commonly used dictionaries, should be interpreted as having a meaning that is consistent with their meaning in the context of the specification and should not be interpreted in an idealized or overly formal sense unless expressly so defined herein. Well known functions or constructions may not be described in detail for brevity or clarity.

The following section defines some of the terminology used throughout this disclosure. The definitions provided below are intended to be consistent with common usage in the field of satellite imaging, and are for clarification only. However, to the extent that these definitions conflict with common usage, the definitions below are intended to control.

“Image” or “satellite image” is used throughout this disclosure to refer to an image acquired from an aerial or satellite-mounted sensor or camera. Although “satellite image” may be used as a shorthand to describe such images, there is no practical difference between an image acquired from a balloon, a non-orbiting spacecraft, a satellite, an airplane, or any other non-terrestrial sensor or camera. Increasingly, aerial images are obtained from small unmanned aerial vehicles. Imagery obtained by any and all of these types of sensor or cameras are intended to be within the scope of “image” or “satellite image” as used throughout this disclosure.

The image places features at “image coordinates.” The image coordinates are 2-Dimensional entities, typically labeled line and sample, (or line and pixel) for features captured in an image can be based upon an algorithm or model that relates the line and sample image coordinates to ground coordinates.

“Ground coordinates” refer to three dimensional coordinates of mobile pose points, and are typically expressed as latitude, longitude, and height, or X, Y, and Z coordinates in a Cartesian, Earth-Centered EarthFixed coordinate system. “Ground truth” is also used herein to refer not just to ground coordinates, but what is happening at those coordinates, including various human and natural changes that occur in real time.

“Tasking” is a process wherein Earth Observation satellites are directed to capture specific images or data of designated areas or regions of interest at a specific time frame. Unlike routine satellite data collection, which adhere to specific orbit schedules, tasking allows for on-demand capture of high-resolution imagery for immediate understanding of what occurs in the area. Tasking can use Satellite Constellations across multiple sensor types (including but not limited to Electro-Optical, Radar, Lidar, Hyperspectral, Radio Frequency, and Thermal).

As described in aspects depicted in the drawings, it is possible to construct a facsimile of the Earth using an archive of 2D and 3D geodata. The construction of a comprehensive digital model of the Earth, known as a digital twin, is made possible by leveraging a repository of 2D and 3D geodata. This data can be visualized and analyzed to gain geospecific insights into various environments.

One of the key applications of this digital twin is to assess the viability and relative value of different locations, enabling situational awareness and informed decision-making during site selection. By integrating on-demand satellite imagery and other data sources like LiDAR scans, the digital twin can be continuously updated to ensure accuracy and relevance. Furthermore, the inclusion of third-party data allows for specific optimization based on factors such as weather conditions, transportation costs, carbon output, and environmental impact. Geospatial analytics, such as line-of-sight analysis and flood simulations, provide valuable information to evaluate the suitability of potential locations.

This process serves the purpose of providing a comprehensive and accurate understanding of the environment in both 2D and 3D perspectives, aiming to lower costs, reduce lead time, and strategically position observers or assets. It also facilitates the detection of changes within the environment. Traditional methods of location selection, which tend to be time-consuming, expensive, and inefficient, are addressed by the utilization of geospatial data and third-party information through a dedicated application.

By leveraging geospatial data, integrating third-party information, and utilizing geospatial analytics, organizations can make informed decisions, optimize resources, and reduce the time and expenses associated with traditional methods. This comprehensive digital model provides a valuable tool for understanding the environment, making strategic choices, and monitoring changes over time.

The combination of geospatial data products, along with the other major toolsets provided through this application for the purpose of location selection and site monitoring, may be used by embodiments of the disclosure for example. Measurements provided by a 3D data base, combined with the geotypical aesthetics of another data base, may enable users to quickly understand the subjective feel of the site through its representation and gain insights into the logistical components. Geospatial data may allow users to determine characteristics of the land and architecture that may impact production feasibility. Analytics, such as line-of-sight, viewshed analysis, flood simulation, help users to make decisions based on simulating the outcomes of various events happened in different locations, and obtaining more detailed geospatial information. The global availability of these databases, and the ability for users to request an update on those databases via tasking and gain insights that are otherwise available through in-person measurements or LiDAR scans or the like, may be utilized by embodiments of the disclosure. Additionally, metadata may allow users to search for locations based on keywords and attributes.

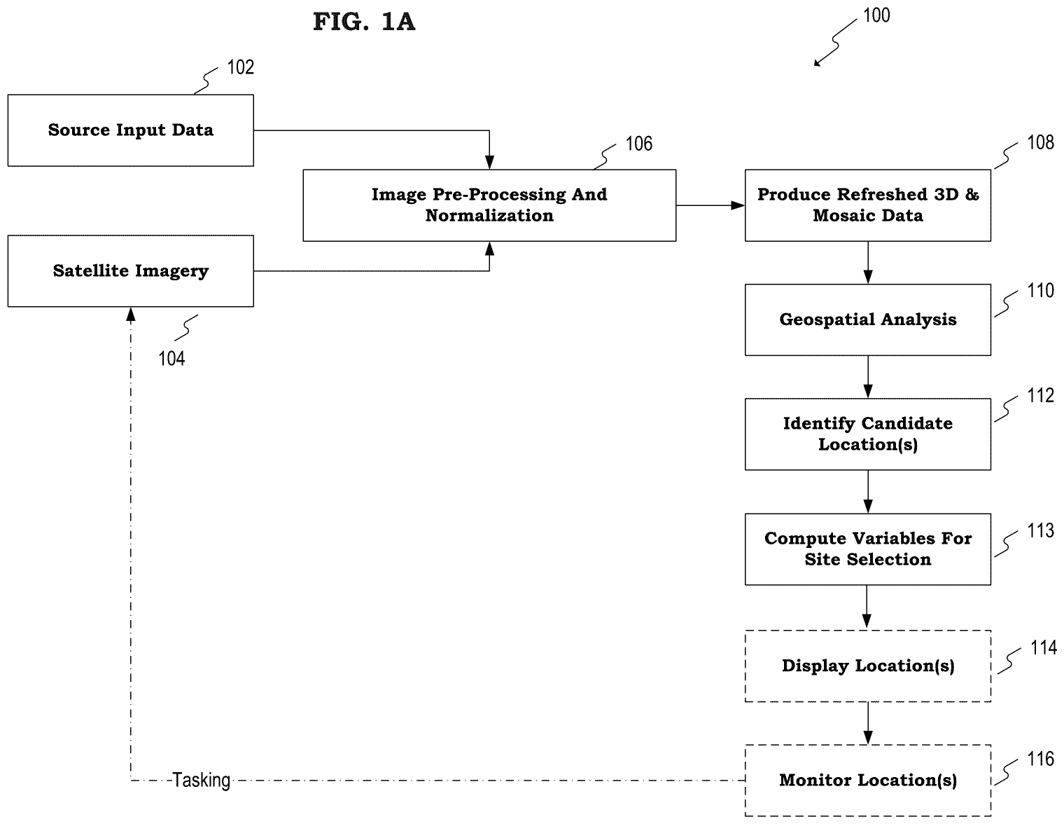

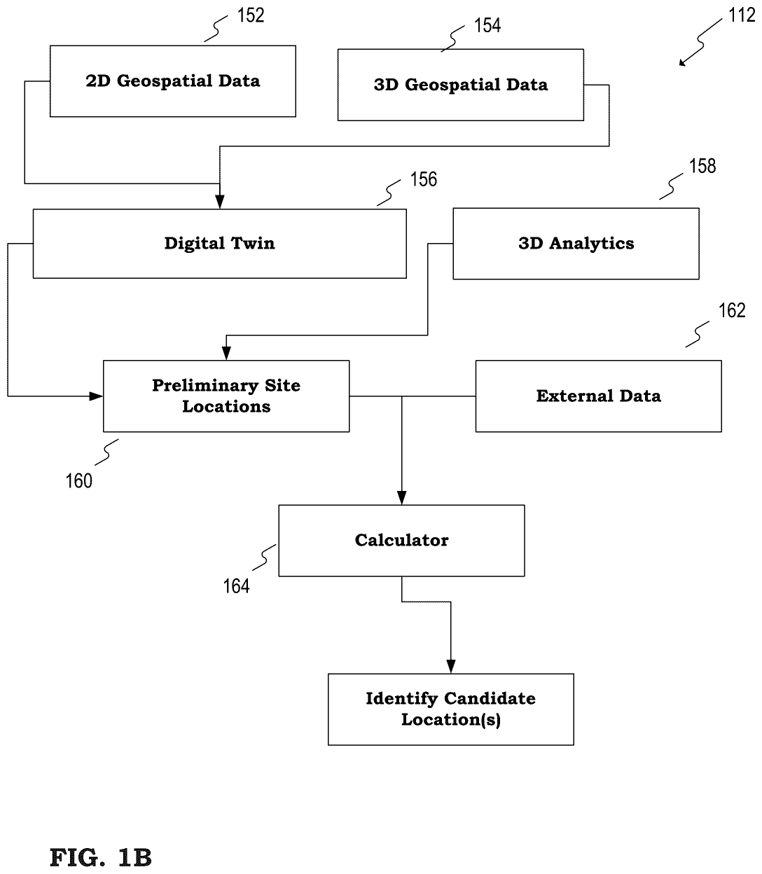

Referring now to FIG. 1A, a method (100) for site selection is depicted as a flowchart. Synthesizing multiple data sources may enable the process consistent with embodiments of the disclosure.

At 102, source data is input. The data that is input at 102 can come from external sources. In this context, “external” refers to sources of data that are publicly accessible, or that are not typically generated or maintained by a satellite imaging company.

Source data 102 can include geospatial data, which includes but is not limited to 2D satellite imagery, 3D surface model data, digital terrain models, digital surface models and digital elevation models, vegetation, classifications, and buildings. Additional external source data 102 can include weather information, geolocation (e.g., fleet tracking), archives of scouted locations, artificial intelligence (AI) or machine learning (ML) training data on geospatial objects to track the movement of important features for site monitoring analysis, and social media data for tipping or queuing features, among others.

By integrating external data sources, users of the process may gain previously unachievable insights or save significant time and effort. Embodiments of the disclosure may pull external data source that includes data points from publicly available sources such as but not limited to municipal data for permitting processes, climate forecasts, AIS vessel information, socioeconomic data, land use/land cover maps, geolocation data and more. The incorporation of historic weather data and a sun-path projector in a 3D viewer application may allow users to experience the location at any time of year or day, providing a comprehensive impression of the site.

The output of the source input data 102 can be a Digital Twin of Earth constructed using archive 2D and 3D geospatial data. In the context of satellite imaging and GIS systems, a Digital Twin refers to a virtual replica or model of the Earth's surface that is created and updated using geospatial data. It is a digital representation of the physical environment, capturing both 2D and 3D aspects of the Earth's features, such as terrain, buildings, vegetation, water bodies, and infrastructure. The Digital Twin can be constructed by combining various data sources obtained at 102, including satellite imagery, aerial photography, LiDAR scans, and other geospatial data.

The Digital Twin serves as a dynamic and accurate representation of the real world, allowing users to visualize and analyze the Earth's surface in a virtual environment. It provides a powerful tool for understanding and interacting with geospatial data, enabling informed decision-making, planning, and analysis. The Digital Twin concept goes beyond just static representation and visualization. It allows for simulations, analysis, and scenario testing in a virtual environment as described in more detail herein. Users can perform geospatial analytics, assess the suitability of locations, conduct environmental impact assessments, and simulate various scenarios using the Digital Twin. This capability provides valuable insights and aids in optimizing resources, planning infrastructure, managing natural resources, and responding to emergencies. However, the Digital Twin may not have the most up-to-date information as the 2D and 3D geospatial data obtained at 102 are static datasets obtained prior to performance of method 100.

Climate forecasts and weather data may be used as input parameters for source input data 102 as part of the method 100 to assess impacts to locations on the ground to help provide additional information beyond spatial and temporal data. For example, while 3D elevation data can help determine slope and gradient, monitoring locations where it has recently rained could have navigation implications on the ground due to soil moisture and potential land subsidence.

At 104, satellite imagery is obtained. It should be understood that satellite imagery 104 is not just obtained at a discrete point in time, but rather can be received at multiple time points or even continuously. As described with respect to the other elements of the method 100, several features of the method 100 (such as monitoring 116, including alerting functionality therein) can be continuous and therefore incorporate periodic, sporadic, or continuous updates in satellite imagery at 104. Tasking, as described herein, can be used to obtain satellite imagery 104 at the desired location and timing.

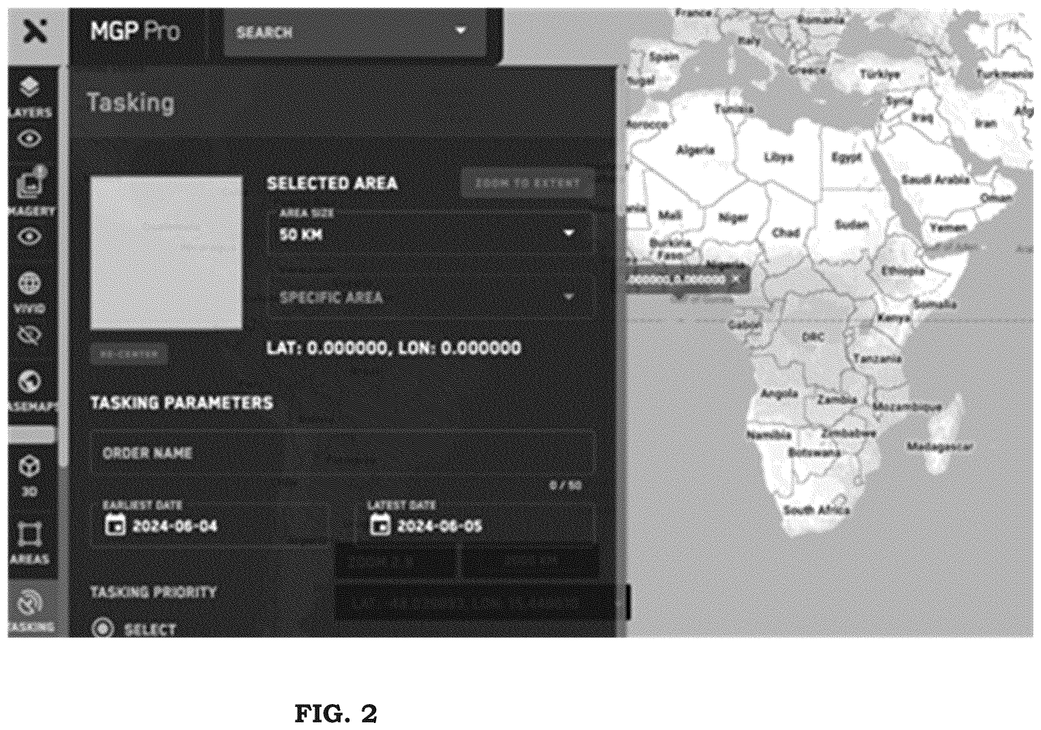

At 104, a user can select an Area of Interest (AOI) and look for newer imagery to update the Digital Twin of Earth. Alternatively, obtaining satellite imagery at 104 can be a tasking function. In such instances, the method can include at 104 tasking a satellite to collect fresh imagery and use that new imagery to update the Digital Twin of Earth. In this embodiment, the user needs to specify the AOI and desired the date that the image to be taken, location for the image, and optional additional other criteria to identify or create the appropriate image. FIG. 2 shows an example of a graphical user interface for tasking the obtaining of satellite imagery at 104 to reflect the most up-to-date environment. Other data, such as in-person measurements or Light Detection and Ranging (LiDAR) scans can create add detailed topographic detail and identify potential locations of interest that otherwise may have been missed.

Returning to FIG. 1A, the source input data at 102 and the satellite imagery at 104 are combined for image pre-processing and normalization at 106. At 106, the data are used to update the Digital Twin.

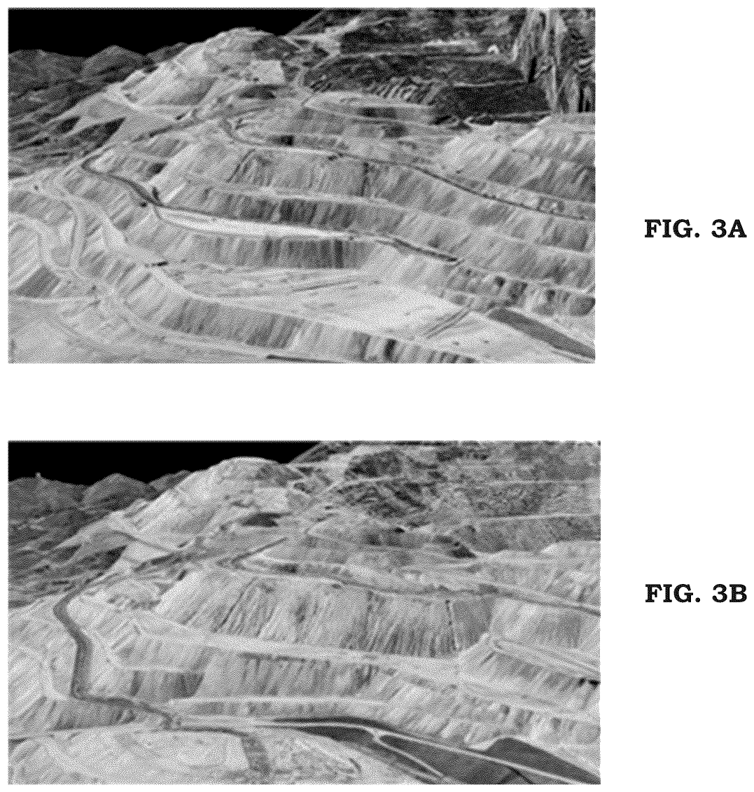

An example of a pre-processed image is shown in FIGS. 3A and 3B.

At 108, a synthesized 3D database (e.g., a machine-generated texture for buildings and vegetation) and a 3D image database of the earth are used to build the Digital Twin and provide a way for users to gain a sense of where potential sites line up with expectations.

Additional details regarding the creation of the Digital Twin at 108 are shown and described with respect to FIG. 1B.

At 110, geospatial analysis is performed. Geospatial analytics refers to the process of analyzing and interpreting spatial data to gain insights, patterns, and relationships within a geographic context. It involves the utilization of advanced techniques, algorithms, and tools to extract meaningful information from geospatial data, such as satellite imagery, GPS coordinates, and digital maps that are collected at 102 and 104. By applying statistical analysis, data mining, machine learning, and visualization methods, geospatial analytics enables the exploration and understanding of spatial patterns, trends, and correlations.

Advanced geospatial analytics are applied to process and interpret the collected data at 110. These analytics include machine learning algorithms and pattern recognition techniques to identify and predict site changes. By automating the analysis process, the system can quickly highlight areas of interest or concern, facilitating proactive decision-making.

Geospatial analysis 110 can use various AI and ML object detection platforms, and leverage advanced AI and ML technologies to provide precise and efficient object detection across various domains. These models are can be trained to identify and classify a wide range of objects, including aircraft, vehicles, vessels, construction equipment, and military equipment, and different models trained for these different purposes may be of interest to different users. Models trained on specific object detection ontologies allow for more precise identification of hyper-specific object detection subclasses. Service providers maintain archives of such ontologies, and those with expansive archives can often find one or more that lends itself to the diversification of trained object detection models and the selection for the user of the site monitoring tool to choose the object classifier that is most of use to their desired monitoring use case.

By utilizing high-resolution satellite imagery and sophisticated algorithms, geospatial analysis 110 enables enhanced situational awareness and decision-making in defense, intelligence, commercial, and humanitarian implementations. These capabilities support critical operations such as monitoring, security, asset management, and disaster response, ensuring reliable and actionable insights in real-time. These object-specific AI/ML models can be object detection models (e.g., Military Object Detection Model, Aircraft Object Detection, Vessel Object Detection, Vehicle Object Detection, Construction Equipment Object Detection, or Railcar Object Detection) or footprint detection models such as railroad detection, roadway detection, or building detection models.

At 112, candidate locations for a particular purpose can be identified. In one example, a user manually selects candidate locations. In another example, a user can identify certain criteria that are of interest, such as elevation, line-of-sight (or lack thereof) between the candidate location and other areas, or phrases or descriptions that correspond to types of GIS data that is used in tagged images on which AI/ML systems are trained.

In identifying candidate locations at 112, analytics 110 may be used to conduct feasibility studies to select candidate locations at 112. Adding a statistical process to normalize, co-register multiple datasets into a single view can better help identify patterns otherwise missed. For example, rapidly generated 3D images reflecting a new building can be combined with the most recent cloud-free satellite imagery can better produce a more accurate set of candidate locations. Based on this accurate, up-to-date information, candidate locations can be identified at 112 by integrating results from feasibility studies, distance calculations, and cost of execution to provide users with recommended sites versus another.

FIG. 1B further depicts how data can be combined to arrive at the identification of candidate locations 112 of FIG. 1A, according to one embodiment.

As shown in FIG. 1B, 2D geospatial data 152 (such as satellite imagery) can be combined with 3D geospatial data 154 (such as digital elevation and other models) to form a digital twin 156.

The digital twin 156 can be combined with 3D analytics 158 to identify preliminary site locations 160. Preliminary site locations 160 can be based upon criteria for a particular use, such as by searching for tagged metadata, or based on line of sight to mountains, buildings, ports, or the like.

External data 162 is combined with preliminary site locations 160 and entered to a calculator 164. As described above, the external data 162 may be data points from publicly available sources such as but not limited to municipal data for permitting processes, climate forecasts, AIS vessel information, socioeconomic data, land use/land cover maps, geolocation data, historic weather data, a sun-path projector in a 3D viewer application, or the like.

Calculator 164 determines the suitability of each of the preliminary site locations for a desired set or criteria or query. For example, a user may request at 102 (FIG. 1A) locations that have line of sight to a particular location and will not be looking into the sun at a particular time of day. Calculator 164 can review the preliminary site locations 160 and eliminate those sites which do not meet all of the criteria. The calculator 164 may, in some examples, take into account current data from tasked satellites or third parties, for example to determine that there is cloud cover and therefore none of the preliminary site locations 160 will be looking into the sun on one day even though some of those preliminary site locations 160 would be looking into the sun on other days or at other times.

Returning to FIG. 1A, at 114 the final locations identified at 112 and selected at 113 can be displayed. Spatial statistic output can be leveraged to identify the variables that help guide site selection. For example the spatial auto correlation of particular object detection results can visualize (e.g., using histograms and heatmaps) where a user should understand patterns of activity in a particular locale. At 114, these spatial statistics in the form of histograms and heatmaps can be displayed.

A 3D viewer may allow users to visualize the 3D environment, conduct analytics, and add labels into scenes to perform the site selection or monitoring process. 2D and 3D geodata may work together by creating a Digital Twin of the Earth that can enable the most refreshed view of the ground truth. The display of the locations at 114 can provide an element of spatial cognition for the user in understanding where identified locations are in relation to one another and in combination with the data that the database provides.

At 116, the locations that were identified can be monitored. Site monitoring at 116 patent application can involve using multisource geospatial data (i.e., from both 102 and 104) in uniform tooling to continuously and accurately track changes and developments at specific locations (i.e., the locations identified at 112).

Site monitoring at 116 can be applied across various industries and sectors, including urban planning, environmental monitoring, disaster response, and military reconnaissance of areas of interest. Areas of interest are specific points for analysis or monitoring using satellite imagery from 104 as well as a host of computer vision algorithms together with tasking collection strategies to understand activity occurring in a particular area.

Examples of monitoring a site or an area of interest at 116 might include tracking of military equipment or personnel, agricultural users looking to understand their crop yield, or urban planners monitoring construction progress and compliance with zoning regulations, while environmental agencies can track deforestation and habitat changes.

Satellite imagery 104 can include high-resolution 2D satellite imagery, enabling detailed and precise observation of areas of interest. This imagery serves as a foundational layer for monitoring various site attributes such as vegetation health, infrastructure development, and land use changes, ensuring that even minor alterations are detectable. Additionally, by incorporating 3D multiview photogrammetry data, the system generates three-dimensional models of sites. This enhancement allows for the visualization of changes in topography, structural developments, and spatial relationships over time, which is useful in applications requiring volumetric analysis and height measurements.

The integration of multi-source data, including weather information, historical site data, and other relevant geospatial datasets, enriches the monitoring capabilities. This comprehensive data amalgamation allows for a more nuanced understanding of site dynamics and contextual influences. Furthermore, the capability for on-demand satellite tasking ensures that the most current and relevant data is available for site monitoring. This feature allows for the rapid acquisition of new satellite imagery in response to specific events or requirements, providing timely insights into dynamic site conditions.

The method 100 performs monitoring 116 after identification of candidate locations 112, but as described above the satellite imagery 104 can be obtained occasionally, regularly, or even continuously. By tasking the collection of satellite imagery at 104 during the monitoring 116, significant resources can be conserved. Tasking of satellites often requires moving, re-orienting, or diverting the optical focus of a satellite in space, which consumes very limited resources and is costly both in the fuel or other energy to accomplish the task, but also in the lost opportunity to capture other images. Similarly, computational efficiency is gained by monitoring 116 and tasking satellites to obtain new satellite imagery at 104 for only those sites that fit the candidate criteria after initial geospatial analysis at 110. Accordingly, timing of satellite tasking can be adjusted to capture a sufficient quantity of satellite image data at relevant times without incurring excessive costs associated with satellite tasking.

By following method 100, identification of candidate locations at 112 is conducted and then only limited tasking (as indicated by the dashed line in FIG. 1) is needed. It should be understood that tasking can also occur at other times along method 100, and not just during monitoring. For example, where additional satellite imagery is needed to conduct geospatial analysis of a particular area at 110, or to make a final determination on candidate locations at 112, tasking can be conducted to obtain additional satellite imagery at 104.

Monitoring 116 can include an alerting function. When implemented, alerting as part of the method 100 can provide real-time alerts and detailed reports at monitoring 116. When significant changes are detected, stakeholders receive immediate notifications, enabling swift action. Regular reports summarizing site conditions and trends are also generated to support long-term monitoring efforts. Additionally or alternatively, AI/ML can be used to determine when a significant change has occurred based on satellite data collected at 104, and alerts can be generated automatically.

By combining these technologies and methodologies, a robust site monitoring solution is provided that provides unparalleled accuracy, timeliness, and depth of insight. This approach will empower users to make informed decisions based on comprehensive and up-to-date geospatial data.

In some examples, integration of tasking to update the Digital Twin of Earth with 2D and 3D geospatial data can be performed. In another example, integration with geospatial analyses can be conducted to assist in various feasibility studies.

There may be various ways for implementing various aspects of method 100 as described herein using software tools. These can include by using any of a variety of programming languages (e.g., a C-family programming language, PYTHON, JAVA, RUST, HASKELL, other languages, or combinations thereof), libraries (e.g., libraries that provide functions for obtaining, processing, and presenting data), compilers, and interpreters to implement aspects described herein. Example libraries include NLTK (Natural Language Toolkit) by Team NLTK (providing natural language functionality), PYTORCH by META (providing machine learning functionality), NUMPY by the NUMPY Developers (providing mathematical functions), and BOOST by the Boost Community (providing various data structures and functions) among others. Operating systems (e.g., WINDOWS, LINUX, MACOS, IOS, and ANDROID) may provide their own libraries or application programming interfaces useful for implementing aspects described herein, including user interfaces and interacting with hardware or software components. Web applications can also be used, such as those implemented using JAVASCRIPT or another language. A person of skill in the art, with the benefit of the disclosure herein, can use programming tools to assist in the creation of software or hardware to achieve techniques described herein. Such tools can include intelligent code completion tools (e.g., INTELLISENSE) and artificial intelligence tools (e.g., GITHUB COPILOT).

One or more of the elements 106, 108, 110, 112, or some combination thereof, can benefit from or be implemented using a machine learning framework. A machine learning framework is a collection of software and data that implements artificial intelligence trained to provide output based on input. Examples of artificial intelligence that can be implemented in a trainable way include neural networks (including recurrent neural networks), language models (including so-called “large language models”), generative models, natural language processing models, adversarial networks, decision trees, Markov models, support vector machines, genetic algorithms, others, or combinations thereof. Machine learning frameworks or components thereof are often built or refined from existing frameworks, such as TENSORFLOW by GOOGLE, INC., PYTORCH by the PYTORCH community, specifically YOLOV8 by Ultralytics. The machine learning framework can include one or more models that are the structured representation of learning and an interface that supports use of the model. The machine learning framework can include one or more models that are the structured representation of learning and an interface that supports use of the model. For instance, YOLOV8 can leverage the COCO dataset to improve object detection and image segmentation tasks, enabling more accurate and efficient model training and deployment.

The model can take any of a variety of forms. In many examples, the model includes representations of nodes (e.g., neural network nodes, decision tree nodes, Markov model nodes, other nodes, or combinations thereof) and connections between nodes (e.g., weighted or unweighted unidirectional or bidirectional connections). In certain implementations, the model can include a representation of memory (e.g., providing long short-term memory functionality). Where the set includes more than one model, the models can be linked, cooperate, or compete to provide output.

The interface can include software procedures (e.g., defined in a library) that facilitate the use of the model, such as by providing a way to interact with the model (e.g., receive and prepare input, processing the input with the model and provide output). The interface can define a vector embedding technique for creating a representation of data usable as input into the model. The software can further provide the ability to create, customize, fine tune, and train the model.

In an example implementation, interface can provide a training method that includes initializing a model, obtaining training data, providing a portion of the training data to the model to produce an actual output, comparing the expected output with the actual output, updating the model based on the result of the comparison (e.g., updating weights of the model, such as using backpropagation), continuing providing training data and updating the model until a stopping criterion has been reached, and deploying the trained model for use in production.

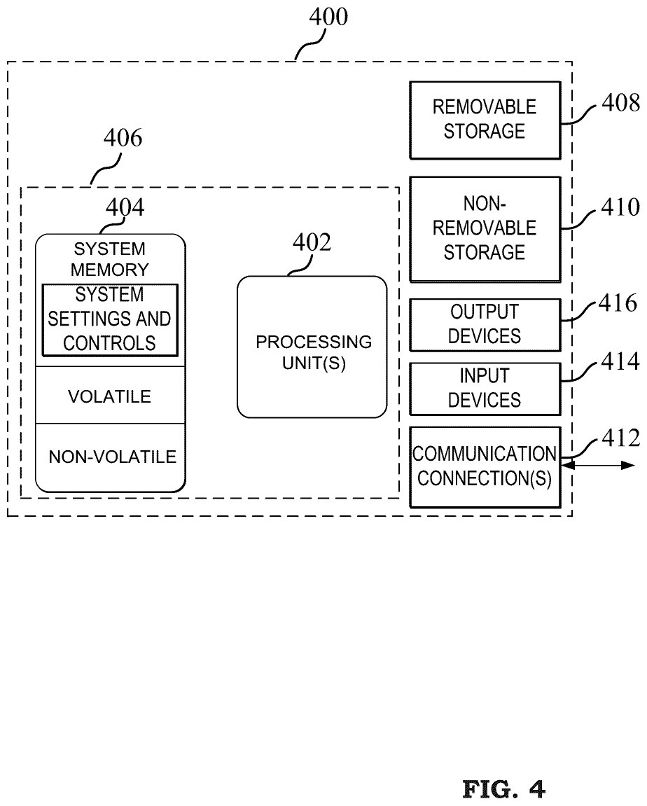

FIG. 4 depicts one example of a suitable operating environment 400 in which one or more of the present examples can be implemented. This is only one example of a suitable operating environment and is not intended to suggest any limitation as to the scope of use or functionality. Other well-known computing systems, environments, and/or configurations that can be suitable for use include, but are not limited to, personal computers, server computers, hand-held or laptop devices, multiprocessor systems, microprocessor-based systems, programmable consumer electronics such as smart phones, network PCs, minicomputers, mainframe computers, tablets, distributed computing environments that include any of the above systems or devices, and the like.

In its most basic configuration, operating environment 400 typically includes at least one processing unit 402 and memory 404. Depending on the exact configuration and type of computing device, memory 404 (storing, among other things, instructions to control the eject the samples, move the stage, or perform other methods disclosed herein) can be volatile (such as RAM), non-volatile (such as ROM, flash memory, etc.), or some combination of the two. This most basic configuration is illustrated in FIG. 4 by dashed line 406. Further, operating environment 400 can also include storage devices (removable, 408, and/or non-removable, 410) including, but not limited to, magnetic or optical disks or tape. Similarly, environment 400 can also have input device(s) 414 such as touch screens, keyboard, mouse, pen, voice input, etc., and/or output device(s) 416 such as a display, speakers, printer, etc. Also included in the environment can be one or more communication connections 412, such as LAN, WAN, point to point, Bluetooth, RF, etc.

Operating environment 400 typically includes at least some form of computer readable media. Computer readable media can be any available media that can be accessed by processing unit 402 or other devices having the operating environment. By way of example, and not limitation, computer readable media can include computer storage media and communication media. Computer storage media includes volatile and nonvolatile, removable and non-removable media implemented in any method or technology for storage of information such as computer readable instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, solid state storage, or any other tangible medium which can be used to store the desired information. Communication media embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media. A computer-readable device is a hardware device incorporating computer storage media.

The operating environment 400 can be a single computer operating in a networked environment using logical connections to one or more remote computers. The remote computer can be a personal computer, a server, a router, a network PC, a peer device or other common network node, and typically includes many or all of the elements described above as well as others not so mentioned. The logical connections can include any method supported by available communications media. Such networking environments are commonplace in offices, enterprise-wide computer networks, intranets and the Internet.

In some examples, the components described herein include such modules or instructions executable by operating environment 400 that can be stored on computer storage medium and other tangible mediums and transmitted in communication media. Computer storage media includes volatile and non-volatile, removable and non-removable media implemented in any method or technology for storage of information such as computer readable instructions, data structures, program modules, or other data. Combinations of any of the above should also be included within the scope of readable media. In some examples, operating environment 400 is part of a network that stores data in remote storage media for use by the operating environment 400.

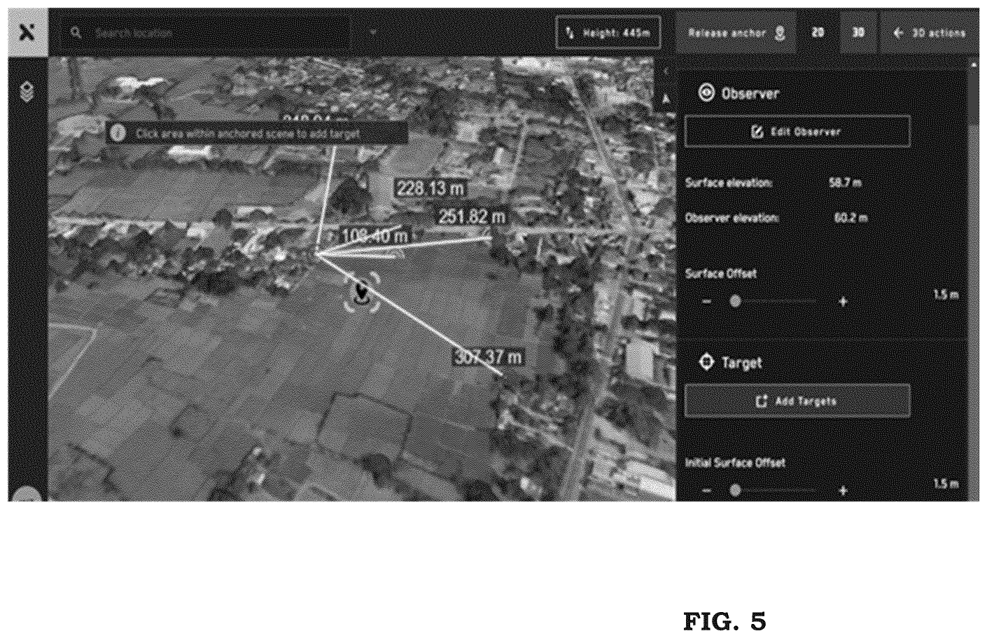

FIG. 5 shows an example of an output of the method described with respect to FIGS. 1A and 1B. FIG. 5 is an example of 110 in FIG. 1A, or 158 in FIG. 1B. In particular, FIG. 5 shows a computer display or GUI that shows a point having an observer location and elevation and line-of-sight to several nearby locations, including the distance to those locations. In other embodiments, as described above, there can be more complex criteria that are input into the system beyond line-of-sight to several proximate locations. FIG. 5 is presented solely to demonstrate a simple example that combines the multiple data sources and a candidate location overlayed onto the digital twin demonstrating conformity with the user requirements. If, for example, the user criteria were to require real-time data there could be satellite tasking involved and the input data to form the image depicted in FIG. 5 could be regularly updated or a data stream.

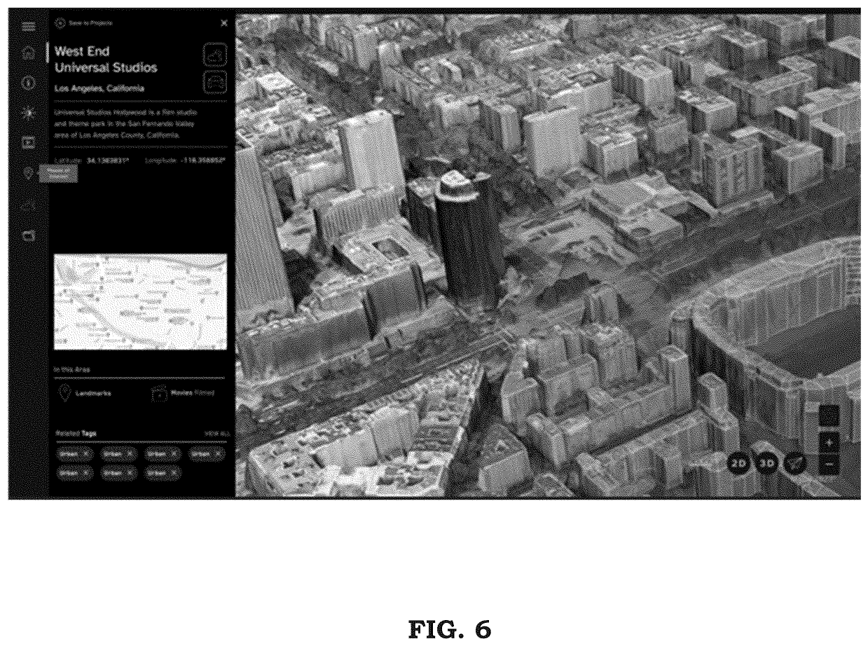

FIG. 6 shows the overlay of multiple data sets, in this case a digital elevation model and building data. FIG. 6 shows an example of a final site selection (for example, at 113 of FIG. 1A) after using geospatial data (156, FIG. 1B) and non-geospatial data (162, FIG. 1B).

While particular uses of the technology have been illustrated and discussed above, the disclosed technology can be used with a variety of data structures and processes in accordance with many examples of the technology. The above discussion is not meant to suggest that the disclosed technology is only suitable for implementation with the data structures shown and described above. For example, while certain technologies described herein were primarily described in the context of queueing structures, technologies disclosed herein are applicable to data structures generally.

This disclosure described some aspects of the present technology with reference to the accompanying drawings, in which only some of the possible aspects were shown. Other aspects can, however, be embodied in many different forms and should not be construed as limited to the aspects set forth herein. Rather, these aspects were provided so that this disclosure was thorough and complete and fully conveyed the scope of the possible aspects to those skilled in the art.

As should be appreciated, the various aspects (e.g., operations, memory arrangements, etc.) described with respect to the figures herein are not intended to limit the technology to the particular aspects described. Accordingly, additional configurations can be used to practice the technology herein and/or some aspects described can be excluded without departing from the methods and systems disclosed herein.

Similarly, where operations of a process are disclosed, those operations are described for purposes of illustrating the present technology and are not intended to limit the disclosure to a particular sequence of operations. For example, the operations can be performed in differing order, two or more operations can be performed concurrently, additional operations can be performed, and disclosed operations can be excluded without departing from the present disclosure. Further, each operation can be accomplished via one or more sub-operations. The disclosed processes can be repeated.

Having described the preferred aspects and implementations of the present disclosure, modifications and equivalents of the disclosed concepts may readily occur to one skilled in the art. However, it is intended that such modifications and equivalents be included within the scope of the claims which are appended hereto.

We claim:

1. A method for remotely identifying physical locations fitting criteria, the method comprising:
obtaining source input data;
obtaining satellite imagery;
pre-processing and normalizing the source input data and the satellite imagery to form a digital earth;
producing refreshed three-dimensional and mosaic data corresponding to the digital earth;
performing geospatial analysis of the refreshed three-dimensional and mosaic data based upon the criteria; and
identifying at least one candidate locations corresponding to the criteria.

2. The method of claim 1, further comprising displaying a three-dimensional image of the at least one candidate location.

3. The method of claim 1, further comprising monitoring the at least one candidate location.

4. The method of claim 3, wherein monitoring the at least one candidate location comprises satellite tasking.

5. The method of claim 4, wherein the satellite tasking is performed at a predefined interval.

6. The method of claim 1, wherein performing geospatial analysis comprises object recognition.

7. The method of claim 1, wherein performing geospatial analysis comprises implementing a machine learning or artificial intelligence algorithm to identify a feature of interest.

8. The method of claim 3, further comprising providing an alert in the event that a change is detected.

9. The method of claim 1, wherein identifying at least one candidate locations comprises:
receiving geospatial data associated with a plurality of locations;
receiving external data associated with the plurality of locations;
constructing a digital twin based upon the geospatial data;
performing geospatial analysis using the digital twin; and
updating the digital twin via satellite tasking.

10. The method of claim 9, wherein the at least one candidate location comprises a plurality of candidate locations, and the method further includes determining, using a calculator, which of the plurality of candidate locations fits the criteria.

11. A non-transitory computer-readable storage medium storing instructions that, when executed by a computer system, cause the computer system to perform operations for remotely identifying physical locations fitting criteria, the operations comprising:
obtaining source input data;
obtaining satellite imagery;
pre-processing and normalizing the source input data and the satellite imagery to form a digital earth;
producing refreshed three-dimensional and mosaic data corresponding to the digital earth;
performing geospatial analysis of the refreshed three-dimensional and mosaic data based upon the criteria; and
identifying at least one candidate locations corresponding to the criteria.

12. The non-transitory computer-readable storage medium of claim 11, the operations further comprising monitoring the at least one candidate location.

13. The non-transitory computer-readable storage medium of claim 11,

14. A computer system comprising:
a non-transitory storage medium having an artificial intelligence algorithm for performing geospatial analysis;
an input configured to receive two-dimensional data from at least one satellite and three-dimensional data corresponding to a plurality of candidate locations and to store the two-dimensional data and the three-dimensional data at the non-transitory storage medium;
a display; and
a processor communicatively coupled to the non-transitory storage medium and carry out the instructions stored on the non-transitory storage medium to:
pre-process and normalize the source input data and the satellite imagery to form a digital earth;
produce refreshed three-dimensional and mosaic data corresponding to the digital earth;
perform geospatial analysis of the refreshed three-dimensional and mosaic data based upon the criteria; and
identify at least one candidate locations corresponding to the criteria, and display the at least one candidate locations on the display.

15. The computer system of claim 14, wherein the processor is further configured to display spatial statistics in the form of histograms and heatmaps regarding object detection results on the display.

16. The computer system of claim 14, wherein the processor is further configured to send a signal directing satellite tasking to produce the refreshed three-dimensional and mosaic data corresponding to the digital earth.

17. The computer system of claim 16, wherein the processor is further configured to monitor the at least one candidate location.

18. The computer system of claim 17, wherein the processor is further configured to monitor the at least one candidate location by sending a signal to perform additional satellite tasking.

19. The computer system of claim 14, wherein the input further comprises an archive of scouted locations.

20. The method of claim 18, wherein the processor is further configured to monitor the candidate locations by modifying a timing of satellite tasking.
